(19) United States
(12) Patent Application Publication
(10) Pub. No.: US 2025/0119708 A1
(43) Pub. Date: Apr. 10, 2025

(54) MULTIPLE SENSING RESOURCE SETS AND FREQUENCY LAYERS FOR INTEGRATED SENSING AND COMMUNICATION

(71) Applicant: ZTE Corporation, Shenzhen (CN)

(72) Inventors: Yihua MA, Shenzhen (CN); Zhifeng YUAN, Shenzhen (CN); Shuqiang XIA, Shenzhen (CN); Guanghui YU, Shenzhen (CN); Liujun HU, Shenzhen (CN); Chuangxin JIANG, Shenzhen (CN); Zhiqiang HAN, Shenzhen (CN)

(21) Appl. No.: 18/983,906

(22) Filed: Dec. 17, 2024

Related U.S. Application Data
(63) Continuation of application No. PCT/CN2022/141505, filed on Dec. 23, 2022.

(51) Int. Cl. H04W 4/02; H04L 5/00; H04L 27/26

(52) U.S. Cl. CPC H04W 4/025; H04L 5/0005; H04L 27/26025

(57) ABSTRACT

This patent document described methods, apparatus, and systems that relate to multiple sensing resource sets sand frequency layers for ISAC and other wireless communication systems. In one example aspect, a method for wireless communication includes determining, by a first wireless device, a plurality of sensing resource positions based on a configuration information indicative of at least one resource sets; and transmitting, by the first wireless device, a sensing signal at the sensing resource positions.

### CROSS-REFERENCE TO RELATED APPLICATION

This patent document is a continuation and claims priority to International Application No. PCT/CN2022/141502, filed on Dec. 23, 2022, the disclosure of which is hereby incorporated by reference herein in its entirety.

### TECHNICAL FIELD

This patent document is related to wireless communication.

BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

### SUMMARY

This patent document discloses techniques, among other things, related to generation, configuration and communication of multiple sensing resource sets and frequency layers for integrated sensing and communication.

In one example aspect, wireless communication method is disclosed. The method includes determining, by a first wireless device, a plurality of sensing resource positions based on a configuration information indicative of at least one resource sets; and transmitting, by the first wireless device, a sensing signal at the sensing resource positions.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

These, and other, aspects are further described throughout the present document.

### BRIEF DESCRIPTION OF THE DRAWING

FIGS. 1-3 show diagrams of examples involving communicating multiple sensing resource sets in wireless communication systems.

FIG. 4 shows a diagram of an example involving two resource sets of the same frequency layer.

FIG. 5 shows a diagram of an example involving three resource sets of the same frequency layer.

FIG. 6 shows a diagram of an example involving three resource sets of two frequency layers.

FIG. 7 shows a diagram of an example involving dealing with resource collision of multiple resource sets.

FIG. 8 shows an exemplary block diagram of a hardware platform that may be a part of a network device or a communication device.

FIG. 9 shows an example of network communication including a base station (BS) and a user equipment (UE) based on some implementations of the disclosed technology.

FIGS. 10-11 are flowcharts representation of methods for wireless communication in accordance with one or more embodiments of the present technology.

### DETAILED DESCRIPTION

Headings for the various sections below are used to facilitate the understanding of the disclosed subject matter and do not limit the scope of the claimed subject matter in any way. Accordingly, one or more features of one section can be combined with one or more features of another section. Furthermore, 6G or Integrated Sensing and Communication (ISAC) terminology is used for clarity of explanation. Still, the techniques disclosed in the present document are not limited to 6G or ISAC technology only and may be used in wireless systems that implement other protocols.

ISAC is expected to add considerable value to the wireless communication system. The widely deployed communication infrastructures can be enhanced to provide radar services like traffic control and surveillance, drone detection, and railway obstacle detection. The various mobile communication devices in the scenarios of autonomous driving, smart home, and health care can also realize ISAC.

The communication system and radar system utilize electromagnetic waves in two different ways. The idea of dual-function design can be traced back to the 1960s. It has attracted more and more research attention in recent years, and there are many driving factors, including (1) the spectrum has been well exploited for two separate systems, and the joint spectrum utilization is expected to improve the efficiency and flexibility; (2) the hardware designs both have a technology trend of multiple antennas and digital baseband, and the share of hardware saves the cost; (3) the information fusion and mutual reinforcement of two functions bring performance gain, especially for autonomous vehicles. The existing radar usually transmits a group of periodic wideband sensing signals. However, to coexist with the communication function, the resource allocation should be more flexible.

In a radar system, a group of periodic wideband sensing signals is usually transmitted. However, in an ISAC or other communication system, the time-frequency resources are required to be shared between sensing and communication. The periodic wideband resource allocation of sensing signals will consume a lot of resources, which is not friendly to the communication service. Therefore, ISAC requires a more flexible manner of allocating the sensing signals to reduce the overheads.

This patent application proposes methods and schemes involving multiple resource allocation patterns that can be used flexibly in ISAC and other communication systems. The proposed methods and schemes improve the system performance due to at least reducing the overheads involved in the communication process.

The details of the proposed methods will be discussed in the following embodiments.

### Embodiment 1

This section discloses, among other things, examples of how a sensing resource pattern is configured and transmitted within a wireless communication system.

The sensing resource pattern can be configured through a higher layer node.

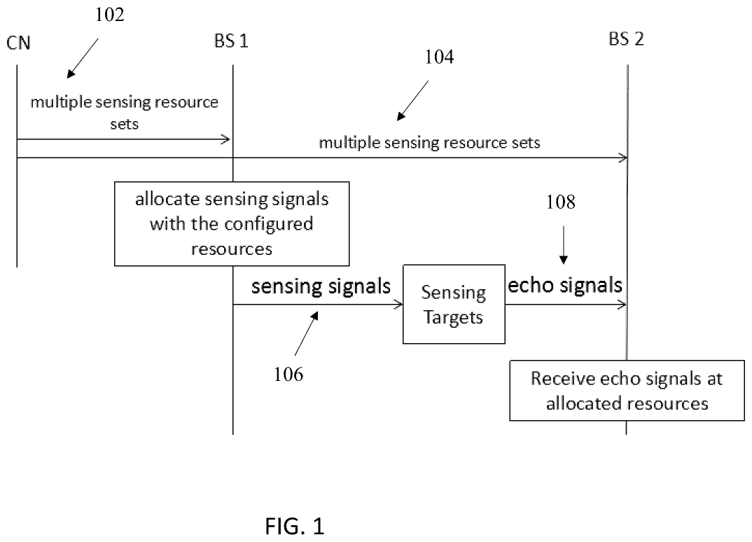

In one example, a Core Network (CN) may transmit the configuration information of multiple sensing resource sets directly to BSs. As shown in FIG. 1, a CN transmits multiple sensing resource sets to B1 (102) and B2 (104).

The configuration information of multiple sensing resource sets may contain at least one of the following: resource set ID, periodicity and resource set slot offset, resource repetition factor, resource time gap, muting options, SFNO Offset, resource list, comb size, resource bandwidth, starting Physical Resource Block (PRB), or the number of symbols within a slot.

According to FIG. 1, BS 1 receives the configuration information and allocates the sensing signals according to the configured information.

BS1 transmits the sensing signal out (106). The sensing signals arrive at the sensing targets and the corresponding echo signals propagate to the receive antennas of BS2 (108).

Since BS2 already received the multiple sensing resource sets from CN, BS2 receives the echo signal according to the sensing resource sets.

### Embodiment 2

This section discloses, among other things, examples involving how the sensing resource pattern is configured and transmitted within a wireless communication network. The sensing resource pattern can be configured through a higher layer node.

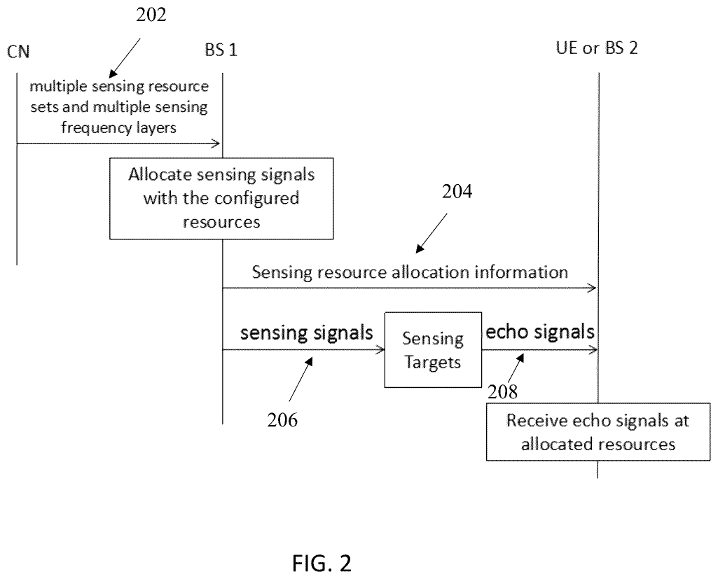

In one example, a CN may transmit the configuration information of multiple sensing resource sets directly to BSs. As shown in FIG. 2, CN transmits multiple sensing resource sets and multiple frequency layers to BS1 (202).

The configuration information of multiple sensing resource sets may contain at least one of the following: resource set ID, periodicity and resource set slot offset, resource repetition factor, resource time gap, muting options, SFNO Offset, resource list, comb size, resource bandwidth, starting PRB, or the number of symbols within a slot.

The configuration information of multiple frequency layers may contain the same parameters. For example, the parameters may include sub-carrier spacing, cyclic prefix and Point A. In other words, two frequency resources can be determined to be of the same layer if they both have the same sub-carrier spacing, cyclic prefix, and/or Point A.

As shown in FIG. 2, BS 1 receives the configuration information and allocates the sensing signals according to the configured information.

BS1 transmits the sensing resource allocation information to UE or BS2 (204). Afterwards, BS1 transmits the sensing signal out (206).

The sensing signals may arrive at the sensing targets, and the corresponding echo signals propagate to the receive antennas of UE or BS 2 (208).

Since UE or BS2 already receives the sensing resource allocation information from BS1, UE or BS 2 may receive the echo signal according to the resource configuration.

### Embodiment 3

This embodiment discloses, among other things, multiple examples involving how the sensing resource pattern is configured and transmitted within a wireless communication network.

The sensing resource pattern can be configured through a higher layer node.

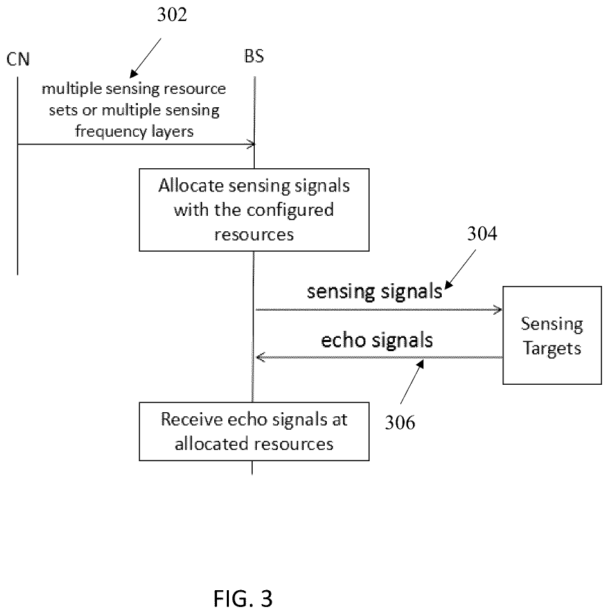

In one example, a CN may transmit the configuration information of multiple sensing resource sets directly to BSs. As shown in FIG. 3, CN transmits multiple sensing resource sets and multiple frequency layers to BS (302).

This embodiment shows how the sensing resource pattern is configured and transmitted. CN directly transmits the configuration information of multiple sensing resource sets and multiple frequency layers to BS 1.

The configuration information of multiple sensing resource sets may contain at least one of the following: resource set ID, periodicity and resource set slot offset, resource repetition factor, resource time gap, muting options, SFNO Offset, resource list, comb size, resource bandwidth, start PRB, or the number of symbols within a slot.

The configuration information of multiple frequency layers may contain the same parameters. For example, the parameters may include sub-carrier spacing, cyclic prefixes, and Point A. In other words, two frequency resources can be determined to be of the same layer if they both have the same sub-carrier spacing, cyclic prefix, and/or Point A.

As shown in FIG. 3, BS receives the configuration information and allocates the sensing signals according to the configured information.

BS transmits the sensing signals out (304).

The sensing signals may arrive at the sensing targets, and the corresponding echo signals propagate back to BS (306).

Since BS already receives the sensing resource allocation information from CN, BS may receive the echo signal according to the resource configuration.

### Embodiment 4

This embodiment discloses, among other things, one involving a configuration of multiple sensing resource sets.

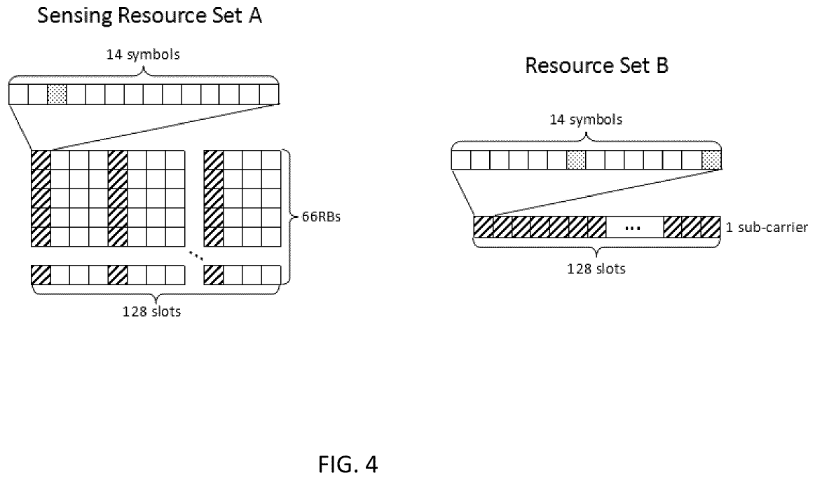

For example, as shown in FIG. 4, two different time resource sets can be configured.

The resource positions of two resource sets are represented by 1) a resource set ID, 2) a periodicity and resource set slot offset, 3) a resource repetition factor, 4) a resource time gap, 5) parameters indicating muting options, 6) an SFNO Offset, 7) a resource list, 8) comb size, 9) resource bandwidth, 10) starting Physical Resource Block (PRB), or 11) number of symbols within a slot in the multiple resource set configurations.

The resource list includes the resources of at least one resource sets, and the resources are further represented by 1) resource ID, 2) sequence ID, 3) comb size and resource element offset, 4) resource slot offset, 5) resource symbol offset and 6) quasi-colocation (QCL) information.

The configuration aims to make the sensing resource sets have different time and frequency patterns to gain sensing results of different ranges and Doppler resolutions. Some algorithms use the sensing results of different resolutions to obtain a common high-resolution sensing result. The common sensing result can be transmitted to at least one core network, a server close to the second or third wireless device.

As shown in FIG. 4, resource A has a bandwidth of 66 resource blocks (RBs) and a periodicity or repetition factor of 4 slots. In other words, Set A can be configured to use the first of every four slots to be used for transmitting the information. In each one of the selected first slots, Set A can be further configured to use the third symbol out of the 14 symbols to transmit related information.

Resource B has a bandwidth of 1 sub-carrier and a periodicity or repetition factor of 7symbols. In other words, Set B can be configured to all the slots among the 128 slots to be used for transmitting the information. In each of the 128 slots, Set B can be further configured to use the 7th and 14th symbols out of the 14 symbols to transmit related information.

The example in this embodiment indicates the proposed multiple sensing resource sets scheme can achieve flexibility in resource allocation. In particular, a resource set (sensing resource set A) with a relatively wide band (e.g., 66 RBs) in frequency and less frequent occupancy in time (one out of four slots and one out of 14 symbols) can be generated together with a resource set (sensing resource set B) with a relatively narrow band (e.g., one sub-carrier) in frequency and more frequently occupancy in time (every slot and two out of 14 symbols).

A network node that receives the configuration of the two different sensing sets may utilize the resource allocation patterns based on different communication scenarios. As the two sensing sets have different bandwidths and time-domain densities, joint processing can be adopted to provide high-performance sensing results. However, conventional methods gaining such a performance require much more resource overheads. Therefore, the proposed method increases efficiency and saves resource allocation of the wireless communication network. Since a common sensing result is obtained from multiple sensing resource sets, the sensing result transmission overheads, or the feedback overheads, can also be reduced.

### Embodiment 5

This embodiment discloses, among other things, examples involving a configuration of multiple resource sets.

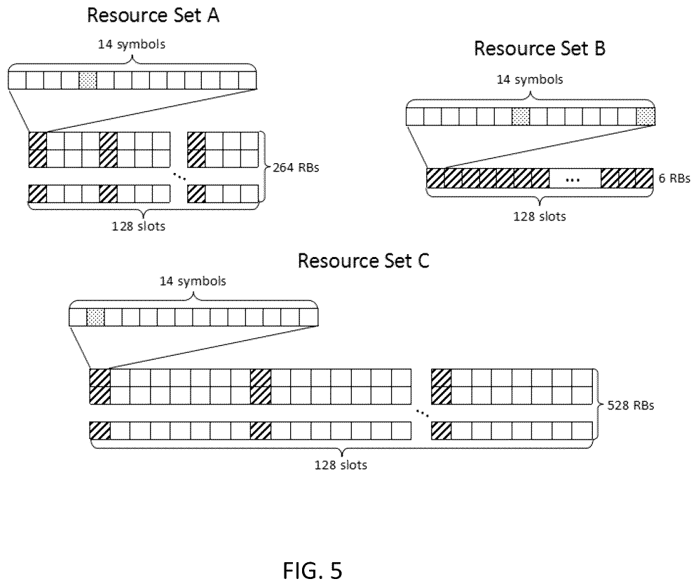

For example, as shown in FIG. 5, three different time resource sets can be configured.

The resource positions of resource sets are represented by 1) a resource set ID, 2) a periodicity and resource set slot offset, 3) a resource repetition factor, 4) a resource time gap, 5) parameters indicating muting options, 6) an SFNO Offset, 7) a resource list, 8) comb size, 9) resource bandwidth, 10) starting Physical Resource Block (PRB), or 11) number of symbols within a slot in the multiple resource set configurations.

The resource list includes the resources of at least one resource sets, and the resources are further represented by 1) resource ID, 2) sequence ID, 3) comb size and resource element offset, 4) resource slot offset, 5) resource symbol offset and 6) QCL information.

The configuration aims to make the sensing resource sets have different time and frequency patterns to gain sensing results of different ranges and Doppler resolutions. Some algorithms use the sensing results of different resolutions to obtain a common high-resolution sensing result. The common sensing result can be transmitted to at least one core network, a server close to the second or third wireless device.

As shown in FIG. 5, resource A has a bandwidth of 264 resource blocks (RBs), and a periodicity or repetition factor of 4 slots. In other words, Set A can be configured to use the first of every four slots to be used for transmitting the information. In each one of the selected first slots, Set A can be further configured to use the fifth symbol out of the 14 symbols to transmit related information.

Resource B has a bandwidth of 6 RB and a periodicity or repetition factor of 7 symbols. In other words, Set B can be configured to all the slots among the 128 slots to be used for transmitting the information. In each one of the 128 slots, Set B can be further configured to use the 7th and 14th symbols out of the 14 symbols to transmit related information.

Resource C has a bandwidth of 528 RB and a periodicity or repetition factor of 8 slots. In other words, Set C can be configured to use the first of every eight slots among the 128 slots. In each one of the 128 slots, Set C can be further configured to use the second symbol out of the 14 symbols to transmit related information.

The example in this embodiment indicates the proposed multiple sensing resource sets scheme can achieve flexibility in resource allocation. Sensing resource set A has a relatively wide band (e.g., 264 RBs) in frequency and less frequent occupancy in time (one out of four slots and one out of 14 symbols). Sending resource set B has a relatively narrow band (e.g., 6 RB) in frequency and more frequent occupancy in time (every slot and two out of 14 symbols). Sensing resource set, C occupies a very large frequency band (e.g., 528 RBs) and little occupancy in time (one out of seven slots and one out of 14 symbols).

A network node that receives the configuration of the three different sensing sets may utilize the resource allocation patterns based on different communication scenarios. As the sensing sets have different bandwidths and time-domain densities, joint processing can be adopted to provide high-performance sensing results. However, conventional methods gaining such a performance require much more resource overheads. Therefore, the proposed method increases efficiency and saves resource allocation of the wireless communication network. Since a common sensing result is obtained from multiple sensing resource sets, the sensing result transmission overheads, or the feedback overheads, can also be reduced.

### Embodiment 6

This embodiment discloses, among other things, examples involving a configuration of multiple resource sets in different layers.

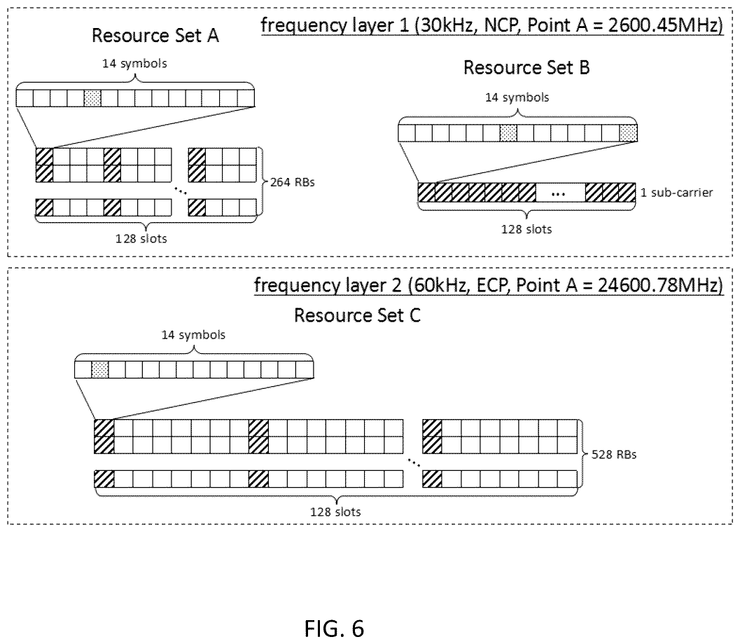

FIG. 6 discloses an example of three different time resource sets on two different frequency layers.

The resource positions of resource sets are represented by 1) a resource set ID, 2) a periodicity and resource set slot offset, 3) a resource repetition factor, 4) a resource time gap, 5) parameters indicating muting options, 6) an SFNO Offset, 7) a resource list, 8) comb size, 9) resource bandwidth, 10) starting Physical Resource Block (PRB), or 11) number of symbols within a slot in the multiple resource set configurations.

The resource list includes the resources of at least one resource sets, and the resources are further represented by 1) resource ID, 2) sequence ID, 3) comb size and resource element offset, 4) resource slot offset, 5) resource symbol offset and 6) QCL information.

The configuration aims to make the sensing resource sets have different time and frequency patterns to gain sensing results of different ranges and Doppler resolutions. Some algorithms use the sensing results of different resolutions to obtain a common high-resolution sensing result. The common sensing result can be transmitted to at least one core network, a server close to the second or third wireless device.

Frequency resources of different layers may have different values for certain parameters, e.g., sub-carrier spacing, cyclic prefix, or Point A.

For example, in the example shown in FIG. 6, frequency layer 1 has a sub-carrier spacing of 30 kHz, a normal cyclic prefix, and a Point A of 2600.45 MHz. Frequency layer 2 has a sub-carrier spacing of 60 kHz, an extended cyclic prefix, and a Point A of 24600.78 MHz.

According to FIG. 6, frequency layer 1 has two resource sets, A and B.

As shown in FIG. 6, resource A has a bandwidth of 264 resource blocks (RBs) and a periodicity or repetition factor of 4 slots. In other words, Set A can be configured to use the first of every four slots to be used for transmitting the information. In each one of the selected first slots, Set A can be further configured to use the fifth symbol out of the 14 symbols to transmit related information.

Resource B has a bandwidth of 1 sub-carrier and a periodicity or repetition factor of 7 symbols. In other words, Set B can be configured to all the slots among the 128 slots to be used for transmitting the information. In each one of the 128 slots, Set B can be further configured to use the 7th and 14th symbols out of the 14 symbols to transmit related information.

According to FIG. 6, frequency layer 2 has one resource set C.

Resource C has a bandwidth of 528 RB and a periodicity or repetition factor of 8 slots. In other words, Set C can be configured to use the first of every eight slots among the 128 slots. In each one of the 128 slots, Set C can be further configured to use the second symbol out of the 14 symbols to transmit related information.

The example in this embodiment indicates the proposed multiple sensing resource sets scheme can achieve flexibility in resource allocation. In particular, sensing resource set A has a wide band (e.g., 264 RBs) in frequency and less frequent occupancy in time (one out of four slots and one out of 14 symbols). Sending resource set B has a relatively narrow band (e.g., 6 RB) in frequency and more frequent occupancy in time (every slot and two out of 14 symbols). Sensing resource set C occupies a very large frequency band (e.g., 528 RBs) and little occupancy in time (one out of seven slots and one out of 14 symbols). Furthermore, the three sensing resource sets are of different frequency layers.

A network node that receives the configuration of the three different sensing sets may utilize the resource allocation patterns based on different communication scenarios. As the sensing sets have different bandwidths and time-domain densities, joint processing can be adopted to provide high-performance sensing results. However, conventional methods gaining such a performance require much more resource overheads. Therefore, the proposed method increases efficiency and saves resource allocation of the wireless communication network. Since a common sensing result is obtained from multiple sensing resource sets, the sensing result transmission overheads, or the feedback overheads, can also be reduced.

### Embodiment 7

This embodiment discloses, among other things, examples involving how to deal with the resource collision of multiple resource sets.

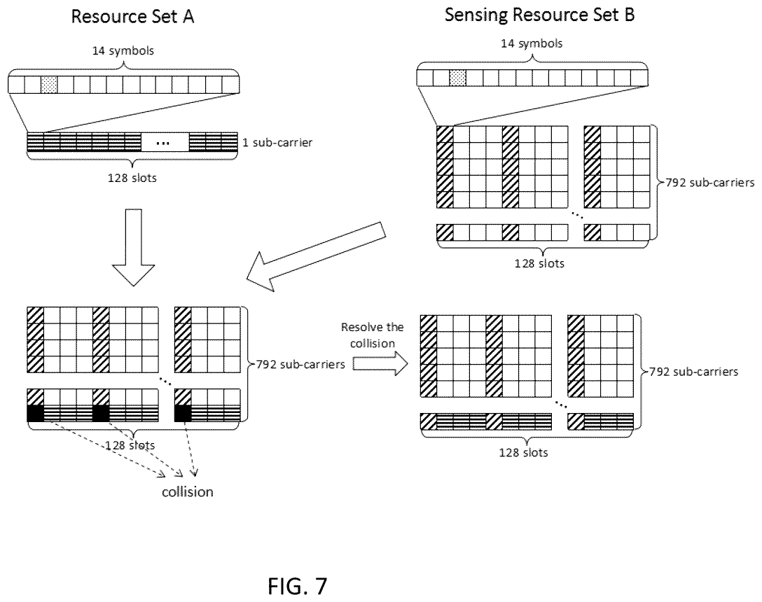

FIG. 7 discloses a scenario of resource allocation collision for two resource sets.

According to FIG. 7, two resource sets, A and B, are of the same frequency layer.

Resource A has a bandwidth of 1 sub-carrier and a periodicity or repetition factor of 1 slot. In other words, Set A can be configured to use all the slots among the 128 slots for transmitting the information. In each slot, Set A can be further configured to use the third symbol out of the 14 symbols to transmit related information.

Resource B has a bandwidth of 792 sub-carriers and a periodicity or repetition factor of 4 slots. In other words, Set B can be configured to the first one of every four slots, among the 128 slots, for transmitting the information. In each one of the 128 slots, Set B can be further configured to use the third out of the 14 symbols to transmit related information.

As shown in FIG. 7, sets A and B use the third symbol in the selected slot, which causes a potential resource allocation collision.

Multiple solutions can be adopted to resolve resource allocation collusion.

For example. one way to remove the resource collision is to set some muting options. In one example, as shown in FIG. 7, resource set A can adopt an option of muting every four slots. In other words, set A may avoid transmitting at the first of every four slots, which avoids the potential allocation collusion with set B at each of the first out of 4 slots.

The second way is to configure priority options and allow only the resource set with higher priority to use the collided resource. For example, sets A and B may be configured with different priorities to use time-frequency resources. When a collision happens, the one with higher priority between set A and set B is authorized to use the resource.

The third way is to resolve the collision via a rule involving the resource set index and a pre-defined rule. For example, the resource set of a smaller index uses the collided resource.

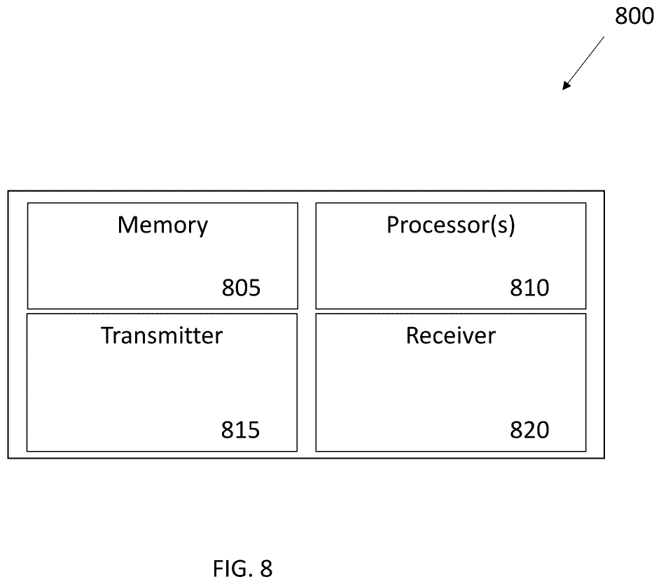

FIG. 8 shows an exemplary block diagram of a hardware platform 800 that may be a part of a network device (e.g., base station) or a communication device (e.g., a user equipment (UE)). The hardware platform 800 includes at least one processor 810 and a memory 805 having instructions stored thereupon. The instructions upon execution by the processor 810 configure the hardware platform 800 to perform the operations described in FIGS. 1 to 7 and in the various embodiments described in this patent document. The transmitter 815 transmits or sends information or data to another device. For example, a network device transmitter can send a message to user equipment. The receiver 820 receives information or data transmitted or sent by another device. For example, user equipment can receive a message from a network device.

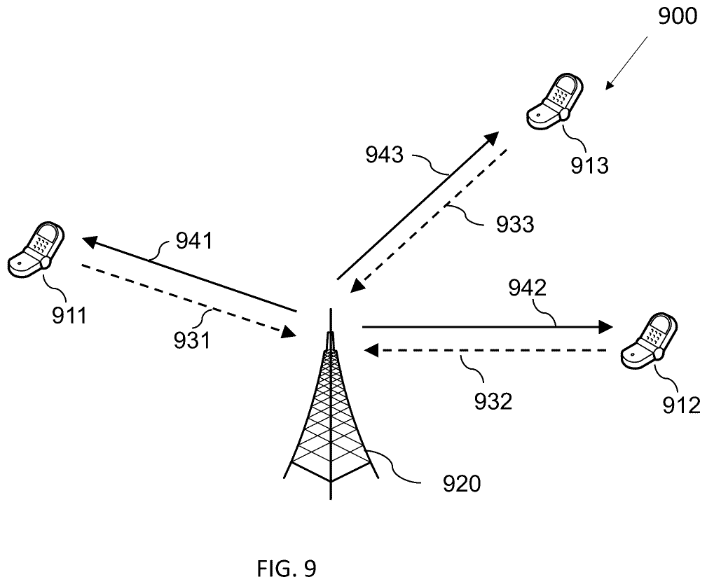

The implementations as discussed above will apply to a network communication. FIG. 9 shows an example of a communication system (e.g., a 6G or NR cellular network) that includes a base station 920 and one or more user equipment (UE) 911, 912 and 913. In some embodiments, the UEs access the BS (e.g., the network) using a communication link to the network (sometimes called uplink direction, as depicted by dashed arrows 931, 932, 933), which then enables subsequent communication (e.g., shown in the direction from the network to the UEs, sometimes called downlink direction, shown by arrows 941, 942, 943) from the BS to the UEs. In some embodiments, the BS send information to the UEs (sometimes called downlink direction, as depicted by arrows 941, 942, 943), which then enables subsequent communication (e.g., shown in the direction from the UEs to the BS, sometimes called uplink direction, shown by dashed arrows 931, 932, 933) from the UEs to the BS. The UE may be, for example, a smartphone, a tablet, a mobile computer, a machine to machine (M2M) device, an Internet of Things (IoT) device, and so on.

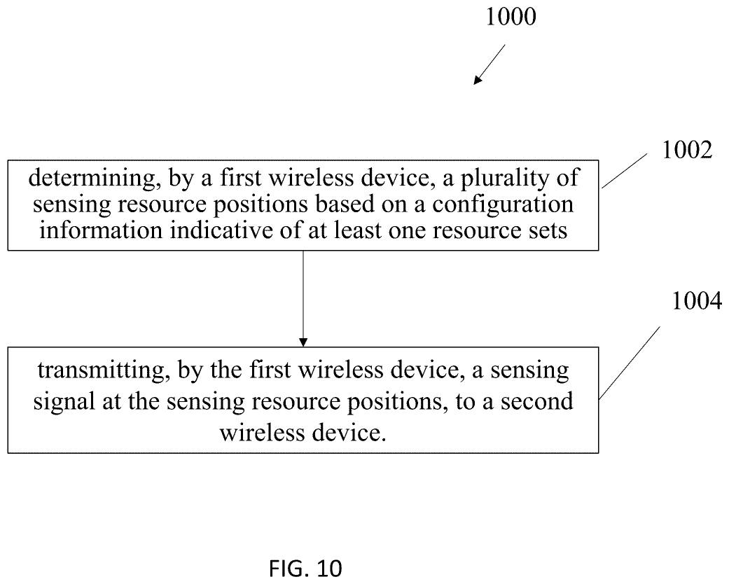

FIG. 10 shows an example flowchart representation of a method for wireless communication in accordance with one or more embodiments of the present technology. Operation 1002 includes determining, by a first wireless device, a plurality of sensing resource positions based on a configuration information indicative of at least one resource sets in at least one frequency layers, wherein the at least one frequency layer is a collection of sensing resource sets that have a group of common parameters, wherein the common parameters comprising 1) a parameter indicating a sub-carrier spacing information, 2) a parameter indicating whether normal cyclic prefix or extended cyclic prefix is used, and 3) a parameter indicating a frequency-domain reference point. Operation 1004 includes transmitting, by the first wireless device, a sensing signal at the sensing resource positions, to a second wireless device.

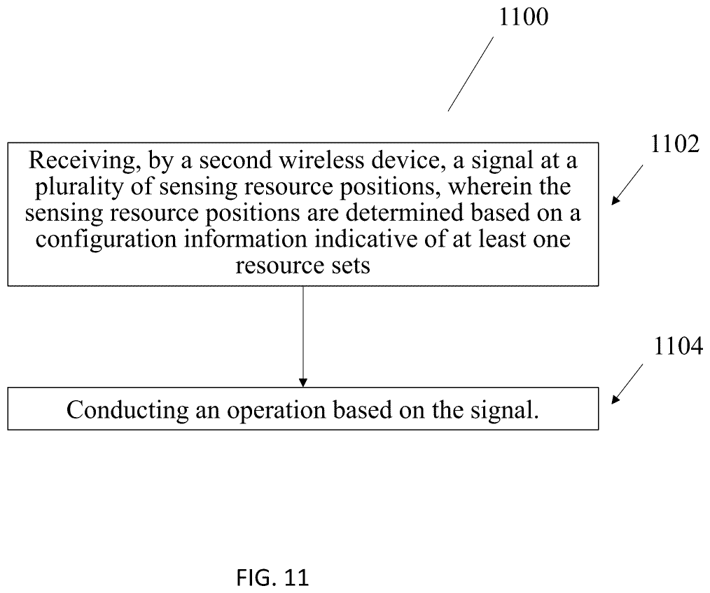

FIG. 11 show an example flowchart representation of a method for wireless communication in accordance with one or more embodiments of the present technology. Operation 1102 includes receiving, by a second wireless device, a signal at a plurality of sensing resource positions, wherein the sensing resource positions are determined based on a configuration information indicative of at least one resource sets in at least one frequency layers, wherein the at least one frequency layer is a collection of sensing resource sets that have a group of common parameters, wherein the common parameters comprising 1) a parameter indicating a sub-carrier spacing information, 2) a parameter indicating whether normal cyclic prefix or extended cyclic prefix is used, and 3) a parameter indicating a frequency-domain reference point. Operation 1104 includes conducting an operation based on the signal.

Various preferred embodiments and additional features of the above-described method of FIGS. 10-11 are as follows. Further examples are described with reference to embodiments 1 to 7.

In one example aspect, a wireless communication method is disclosed. The method includes determining, by a first wireless device, a plurality of sensing resource positions based on a configuration information indicative of at least one resource sets; and transmitting, by the first wireless device, a sensing signal at the sensing resource positions.

In another example aspect, another wireless communication method is disclosed. The method includes receiving, by a second wireless device, a signal at a plurality of sensing resource positions, wherein the sensing resource positions are determined based on a configuration information indicative of at least one resource sets; and conducting an operation based on the signal.

In some embodiments, the resource sets are in at least one frequency layers; where in the at least one frequency layer is a collection of at least one resource sets that have a group of common parameters, wherein the common parameters comprising 1) a parameter indicating a sub-carrier spacing information, 2) a parameter indicating whether normal cyclic prefix or extended cyclic prefix is used, and 3) a parameter indicating a frequency-domain reference point.

In some embodiments, the number of resource sets is fixed to 2.

In some embodiments, a minimum configurable bandwidth of the resource sets is one sub-carrier.

In some embodiments, a bandwidth configuration of the resource sets is represented by a number of sub-carriers.

In some embodiments, the second wireless device obtains sensing information, comprising of at least one of distance information, angle information, velocity information or position information, from a non-line-of-sight wireless channel information of the signal.

In some embodiments, the second wireless device transmits one common sensing information of multiple resource sets to at least one of core network, a server close to the second wireless device, or a third wireless device.

In some embodiments, a maximum configurable resource repetition factor is more than 32.

In some embodiments, the configuration information indicates the resource position information of multiple resource sets comprising at least one of time-domain starting position, time length of one repetition, time-domain repetition period, number of time-domain repetitions, frequency-domain starting position, bandwidth, and frequency-domain comb size.

In some embodiments, the configuration information further comprises at least one of 1) a resource set ID, 2) a periodicity and resource set slot offset, 3) a resource repetition factor, 4) a resource time gap, 5) parameters indicating muting options, 6) a SFNO Offset, 7) a resource list, 8) comb size, 9) resource bandwidth, 10) starting Physical Resource Block (PRB), or 11) number of symbols within a slot.

In some embodiments, a portion of the signal is used as a reference signal or a synchronization signal.

In some embodiments, when resource collision occurs among multiple resource sets, the resource set that has smaller repetition factors, smaller set index, or is being configured with higher priority has priority to use the resource.

In some embodiments, the signal further comprises a sensing resource configuration that is sent to other wireless nodes.

In some embodiments, a sensing resource configuration information is transmitted before transmitting the signal.

It will be appreciated that the present document discloses methods and apparatus related multiple sensing resource sets sand frequency layers for ISAC and other wireless communication systems. In an ISAC or other communication system, the time-frequency resources are required to be shared between sensing and communication. The periodic wideband resource allocation of sensing signals will be resource consuming. Therefore, ISAC requires a more flexible manner of allocating the sensing signals.

This patent application proposes methods and schemes involving multiple resource allocation patterns that can be used flexibly in ISAC and other communication systems. The proposed methods and schemes improve the system performance due to at least reducing the overheads involved in the communication process. The proposed methods and schemes will improve the communication efficiency and accuracy in ISAC and other wireless communication system due to at least reducing overheads.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
determining, by a first wireless device, a plurality of sensing resource positions based on a configuration information indicative of at least one resource set; and
transmitting, by the first wireless device, a sensing signal at the plurality of sensing resource positions.

2. The method of claim 1, wherein the at least one resource sets is in at least one frequency layer; and
wherein the at least one frequency layer is a collection of the at least one resource set that has a group of common parameters, wherein the group of common parameters comprises:
a parameter indicating a sub-carrier spacing information, a parameter indicating whether normal cyclic prefix or extended cyclic prefix is used, and a parameter indicating a frequency-domain reference point.

3. The method of claim 1, wherein a number of the at least one resource set is fixed to 2.

4. The method of claim 1, wherein a minimum configurable bandwidth of the resource sets is one sub-carrier, and wherein a bandwidth configuration of the resource sets is represented by a number of sub-carriers.

5. The method of claim 1, wherein the configuration information indicates resource position information of multiple resource sets comprising at least one of time-domain starting position, time length of one repetition, time-domain repetition period, number of time-domain repetitions, frequency-domain starting position, bandwidth, or frequency-domain comb size, and wherein the configuration information further comprises at least one of a resource set ID, a periodicity and resource set slot offset, a resource repetition factor, a resource time gap, parameters indicating muting options, a System Frame Number 0 (SFN0) Offset, a resource list, a comb size, a resource bandwidth, a starting Physical Resource Block (PRB), or a number of symbols within a slot.

6. The method of claim 1, wherein a portion of the sensing signal is used as a reference signal or a synchronization signal.

7. The method of claim 1, wherein, upon a resource collision occurring among multiple resource sets, a resource set that has smaller repetition factors, a smaller set index, or is being configured with higher priority has priority to use a resource.

8. The method of claim 1, wherein the sensing signal further comprises a sensing resource configuration that is sent to other wireless nodes.

9. The method of claim 1, wherein a sensing resource configuration information is transmitted before transmitting the sensing signal.

10. A method for wireless communication, comprising:
receiving, by a second wireless device, a sensing signal at a plurality of sensing resource positions, wherein the plurality of sensing resource positions are determined based on a configuration information indicative of at least one resource set; and
conducting an operation based on the sensing signal.

11. The method of claim 10, wherein the at least one resource set is in at least one frequency layer; and
wherein the at least one frequency layer is a collection of the at least one resource set that has a group of common parameters, wherein the group of common parameters comprises: a parameter indicating a sub-carrier spacing information, a parameter indicating whether normal cyclic prefix or extended cyclic prefix is used, and a parameter indicating a frequency-domain reference point.

12. The method of claim 10, wherein a minimum configurable bandwidth of the at least one resource set is one sub-carrier, and wherein a bandwidth configuration of the at least one resource set is represented by a number of sub-carriers.

13. The method of claim 10, wherein the second wireless device obtains sensing information, comprising of at least one of distance information, angle information, velocity information or position information, from a non-line-of-sight wireless channel information of the sensing signal.

14. The method of claim 10, wherein the second wireless device transmits one common sensing information of multiple resource sets to at least one of core network, a server close to the second wireless device, or a third wireless device.

15. The method of claim 10, wherein a portion of the sensing signal is used as a reference signal or a synchronization signal.

16. The method of claim 10, wherein, upon a resource collision occurring among multiple resource sets, a resource set that has smaller repetition factors, a smaller set index, or is being configured with higher priority has priority to use a resource.

17. The method of claim 10, wherein the sensing signal further comprises a sensing resource configuration that is sent to other wireless nodes.

18. The method of claim 10, wherein a sensing resource configuration information is transmitted before transmitting the sensing signal.

19. An apparatus for wireless communication comprising one or more processors configured to cause the apparatus to:
determine a plurality of sensing resource positions based on a configuration information indicative of at least one resource set; and
transmitting a sensing signal at the plurality of sensing resource positions.

20. An apparatus for wireless communication comprising one or more processors configured to cause the apparatus to:
receive a sensing signal at a plurality of sensing resource positions, wherein the plurality of sensing resource positions are determined based on a configuration information indicative of at least one resource set; and
conduct an operation based on the sensing signal.
